(19) United States
(12) Patent Application Publication
(10) Pub. No.: US 2007/0194745 A1
(43) Pub. Date: Aug. 23, 2007

(54) SPLIT PHASE POLYPHASE INVERTER

(76) Inventor: Alan Giovanni Cocconi, Glendora, CA (US)

Correspondence Address: MCDERMOTT WILL & EMERY LLP, 2049 CENTURY PARK EAST, 38th Floor, LOS ANGELES, CA, 90067-3208, US

(21) Appl. No.: 11/533,213

(22) Filed: Sep. 19, 2006

Related U.S. Application Data
(63) Continuation of application No. 11/253,841, filed on Oct. 19, 2005, now abandoned.
Application No. 11/253,841 is a continuation of application No. 10/655,341, filed on Sep. 4, 2003, now abandoned.
(60) Provisional application No. 60/408,117, filed on Sep. 4, 2002.

(51) Int. Cl. H02P 27/04

(52) U.S. Cl. 318/801

(57) ABSTRACT

A split phase DC to AC polyphase inverter having M phases for driving an M-phase load includes, for each phase, N subphases for producing N PWM signals at a carrier frequency. Associated with each of the M phases is one of M averaging transformers. The N PWM signals associated with each one of the M phases is input into the associated transformer. The transformer produces a PWM signal with a frequency equal to approximately N times that of the carrier frequency of that of the N input PWM signals, and with a maximum voltage step equal to the voltage amplitude V of one of the N input PWM signals divided by N. The result is an inverter circuit which produces much lower output current ripple without increasing the total power consumed by the inverter.

### CROSS-REFERENCE TO RELATED APPLICATION

The present application is a continuation of copending patent application, Ser. Number, 11/253,841, filed Oct. 19, 2005, which is a continuation of application Ser. Number 10/655,341, filed Sep. 4, 2003, which claims priority to provisional application having Ser. No. 60/408,117 filed Sep. 4, 2002, entitled “Split Phase PWM Polyphase Inverter,” the entire content of which is hereby incorporated by reference.

### BACKGROUND

1. Field

The present invention relates generally to electronics, and more specifically to polyphase inverters.

2. Background

A conventional polyphase inverter produces a set of AC signals from a DC power source. An AC signal is output from each “phase” of the polyphase inverter. A single phase includes a pair of semiconductor switches connected in a “totem pole” configuration, analogous to that of a conventional inverter. The inputs to the switches are coupled to logic circuitry configured to define the inverter waveforms. While these waveforms are commonly modulated, their precise nature depends upon the application. The polyphase inverter may be used to drive inductive loads such as LC filters, to provide current to the phases of a polyphase electric motor, or for other applications.

Pulse width modulation (“PWM”) is a scheme often used with inverters for operating electric motors. A common example is a three-phase induction motor in which each phase is separated by 120 degrees. A digital circuit may be coupled to the inputs of a corresponding three-phase inverter to produce three PWM waveforms. Associated with each PWM waveform is a carrier frequency, amplitude, and distinct phase for operating the motor within its specified tolerances. Each output PWM signal trace is coupled to a winding associated with a phase of the motor, thereby feeding current to each phase and providing power to the motor. The PWM voltage waveforms are modified by the logic circuitry as necessary to control motor characteristics like speed, torque, and direction.

Whatever the inverter's application, it is desirable to reduce output ripple and to minimize power losses and noise due to switching transients. Increasing the inverter's switching frequencies reduces ripple current. Unfortunately, this technique also introduces greater switching losses. Likewise, placing a filter inductor at the load to control ripple results in increased mass and bulk, and injects parasitic values into the circuit that risk performance degradation. Various embodiments of the present invention may address these issues.

### SUMMARY

In one aspect of the present invention, a polyphase inverter includes a first conductor, a second conductor, M phases, each phase including N inverters, each inverter including two inverter inputs, an inverter output, a first node coupled to the first conductor and a second node coupled to the second conductor, and M transformers, each transformer comprising N transformer inputs and a transformer output, each of the N transformer outputs from each phase coupled to each of the N inputs of an associated one of the M transformers.

In another aspect of the present invention, a polyphase inverter includes logic circuitry, a first conductor configured to couple to a first terminal of a DC power source, a second conductor configured to couple to a second terminal of the DC power source, M phases, each phase comprising N subphases, each subphase comprising two transistors coupled in an inverter configuration, a first node coupled to the first conductor, a second node connected to the second conductor, two inverter inputs coupled to the logic circuitry, and an inverter output, and M transformers, each transformer comprising N transformer inputs, the N transformer inputs of each transformer being coupled to the N inverter outputs from an associated one of the M phases, and a transformer output configured to couple to a load.

In still another aspect of the invention, a system for driving an electric motor includes a polyphase inverter including a first conductor, a second conductor, M phases wherein each phase comprises N inverters, and wherein each inverter includes two inverter inputs, an inverter output, a first node coupled to the first conductor and a second node coupled to the second conductor, the polyphase inverter further including M transformers, wherein each transformer includes N transformer inputs and a transformer output, and wherein each of the N inverter outputs from each phase is coupled to each of the N inputs of an associated one of the M transformers, and an electric motor including M phases, each phase including an input, the output of each transformer coupled to the input of each phase of the electric motor.

Other embodiments of the present invention will become readily apparent to those skilled in the art from the following detailed description, wherein it is shown and described only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is an drawing of a conventional polyphase inverter having M=3 three phases.

FIG. 2 is a drawing of the polyphase inverter of FIG. 1 using insulated gate bipolar transistors (IGBTs) as the semiconductor switches and a three phase induction motor as the exemplary load.

FIG. 3 is an example of sinusoidal pulse width modulation (PWM) signal and resulting output current and ripple for a single phase of a polyphase inverter with an inductive load.

FIG. 4 is a drawing of a split-phase polyphase inverter in accordance with an embodiment of the present invention.

FIG. 5 is a graphical representation of the waveforms produced by the split-phase polyphase inverter of FIG. 4 in accordance with an embodiment of the invention.

FIG. 6 is a schematic drawing of an averaging transformer having N=3 inputs in accordance with an embodiment of the present invention.

FIG. 7 is a drawing of an exemplary implementation of an averaging transformer with N=3 cores in accordance with an embodiment of the present invention.

FIG. 8 is a drawing of an exemplary implementation of a transformer using three toroids in accordance with an embodiment of the present invention.

FIG. 9 is a drawing of an averaging transformer configuration using three center-tapped transformers in accordance with an embodiment of the present invention.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention.

For the purposes of this disclosure, the term “coupled” means “connected to” and such connection can either be direct or, where appropriate in the context, can be indirect, e.g., through intervening or intermediary devices or other means. Further, the letter N for the purposes of this disclosure represents an integer greater than one. N is used to represent the number of subphases in the novel split-phase polyphase inverter of the invention. The letter M represents an integer greater than one. M is used to represent the number of phases in a polyphase inverter. For example, a polyphase inverter having M=3 phases may have N=3 subphases in accordance with an embodiment of the invention, where each one phase is subdivided into 3 subphases.

Inverters are used in a variety of applications to develop an AC voltage from a DC power source. A polyphase inverter may be used to produce a series of PWM signals. PWM polyphase inverters use solid state switching devices to convert a DC power source into a series of constant-amplitude voltage pulses having changing duty cycles. PWM inverters are used in a wide variety of applications such, for example, driving output filters, driving fluorescent lamps for LCD backlighting, driving dimming switches, supplying power for fuel and solar cells, driving electric motors, and others. The several inverters described herein are equally applicable to these various applications in which it is desirable to minimize output ripple current without creating excessive inverter switching losses. For illustrative purposes and ease of understanding, the inverter will be referenced principally in connection with electric motor applications. Nevertheless, it will be appreciated that the inventive concepts disclosed are equally applicable to a variety of applications using DC inverters. The novel inverter disclosed herein is likewise suitable for these applications.

In the context of electric motor applications, the inverter is usually the primary component of the motor drive. The polyphase inverter may be used to provide current to multi-phase induction motors. The polyphase inverter may convert, for each phase, DC power to AC power at the intended frequency, phase and duty cycle. For a three-phase motor, the inverter includes three half-bridge units where the upper and lower semiconductor switch are controlled in complimentary fashion. As described below, for a PWM inverter the duty cycle characteristics and carrier frequency may be controlled by a digital circuit. The outputs of the digital circuit are coupled to the gates of the semiconductor switches.

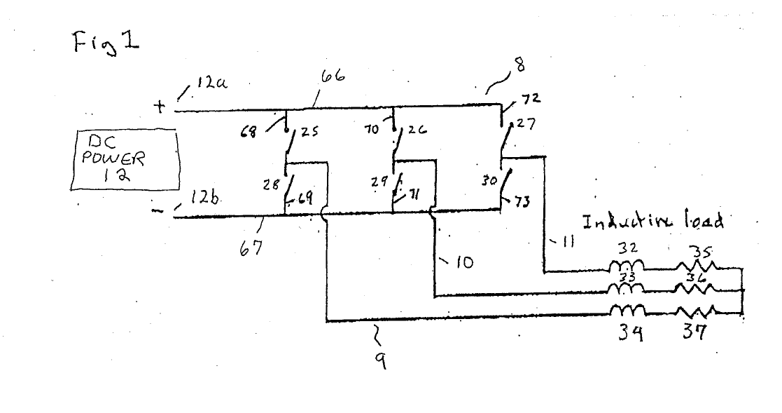

FIG. 1 shows a diagram of a conventional polyphase inverter 8 driving an inductive load. The inductive load in this illustration can be characterized for simplification as a three-phase load including a first phase modeled by inductor 32 and resistor 35, a second phase modeled by inductor 33 and resistor 36, and a third phase modeled by inductor 34 and resistor 37. Each phase of the polyphase inverter in FIG. 1 drives a corresponding phase of the load. Semiconductor switches 25 and 28 in a first phase of the polyphase inverter are used to drive an output line 9 to inductor 34 and resistor 37. Semiconductor switches 26 and 29 in a second phase are used to drive an output line 10 to inductor 33 and resistor 36. Semiconductor switches 27 and 30 in a third phase are used to drive output line 11 to inductor 32 and resistor 35. Semiconductors 25 and 28 are configured as a conventional single stage inverter, as are semiconductors 26 and 29, and semiconductors 27 and 30.

Conductors 66 and 67 are coupled to the load to supply power to the inverter phases. The vertical branches 68, 70, 72, 69, 71 and 73 are nodes, with two nodes for each inverter phase. Each inverter phase has first nodes (68, 70 and 72) and second nodes (28, 29 and 30). The first nodes are coupled to conductor 66 which supplies power from terminal 12a coupled to a power source 12. The second nodes are coupled to conductor 67, which may be couple to a terminal 12b from the same source with a DC voltage of the opposite polarity, or a common (ground) voltage. In this configuration, assuming ideal switches, the DC source dictates the amplitude of the resulting output signals 9, 10 and 11 relative to the power supply.

Semiconductor switches 25, 26, 27, 28, 29 and 30 may include various types of transistors. For electric power applications, insulated gate bipolar transistors (IGBTs) or power MOSFET transistors are often used. Nevertheless, the choice of switch can vary and is dependent upon the application's requirements. The power supply 12 may be a DC battery, for example, or other DC source such as the output of an AC to DC converter. A capacitor may be placed between the positive and negative supply terminals to help stabilize the DC signal. Other passive components may be placed at the input of the inverter to stabilize the DC voltage, such as a series inductor on the power line.

The input to each semiconductor switch in FIG. 1, omitted for clarity, controls whether the switch is open or closed, and is typically driven by logic circuitry as noted above. The logic circuitry may, for example, be part of an integrated circuit such as a digital signal processor, central processing unit (“CPU”), or microcontroller unit (“MCU”). The semiconductor switches in each phase are controlled by an algorithm executed by the control circuitry (not shown) to create the AC waveforms necessary to supply the appropriate amount of power to the load. As described in greater detail below, PWM is a standard modulation technique for providing power to many kinds of both AC and DC motors and to drive inductive loads in other types of applications.

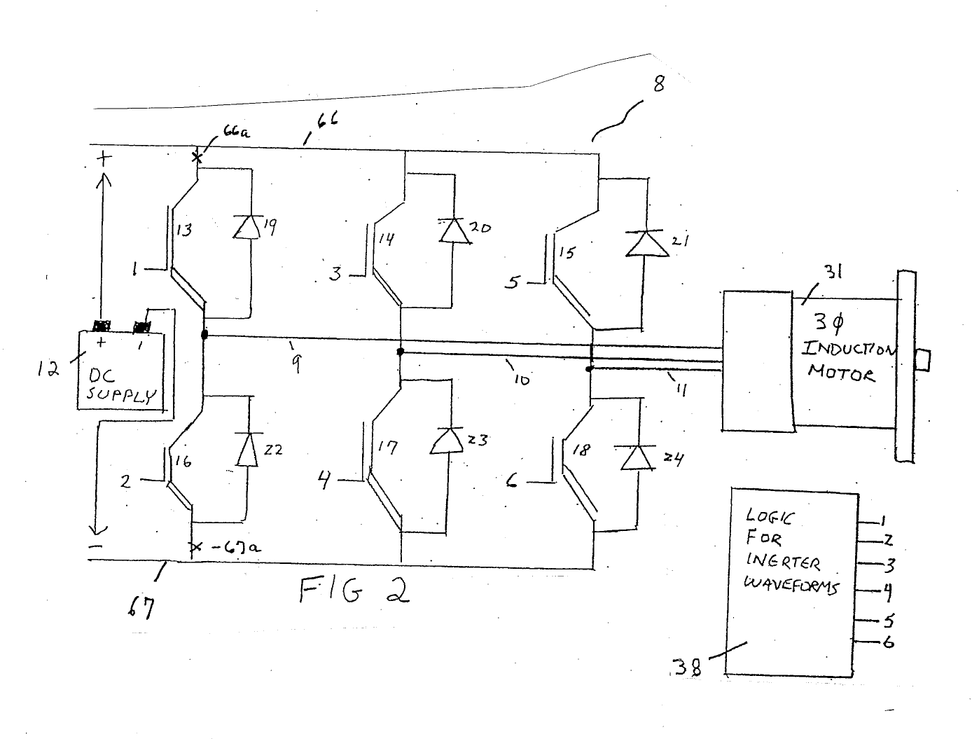

FIG. 2 is an illustration of a more detailed implementation of the inverter 8 shown in FIG. 1. In this embodiment, each of the switches 13, 14, 15, 16, 17 and 18 is an IGBT transistor having gate inputs 1, 3, 5, 2, 4 and 6. Across each transistor 13, 14, 15, 16, 17 and 18, respectively, are diodes 19, 20, 21, 22, 23, and 24 which are used to clamp random voltage transients and steer current during normal PWM operation. Each phase includes two transistors and their associated diodes and connections to power. One phase includes, for example, IGBTs 13 and 16, together with diodes 19 and 22 and associated connections to power via the connection between conductors 66 and 67, respectively, to first node 66a and lower node 67a, and inverter output line 9. This phase, like each phase of the inverter, is configured in “inverter” fashion, meaning that one (non-gate) terminal from each transistor is connected at line 9, and the other (non-gate) terminals of the transistors 13 and 16 are coupled to the power source at terminals 12a and 12b via first node 66a and second node 66b. As another example, if the transistors 13 and 16 were power metal-oxide-semiconductor field effect transistors (MOSFETs) in a complimentary metal-oxide-semiconductor (CMOS) configuration, the drains of the MOSFETS would be coupled at line 9 and the sources of MOSFETs 13 and 16 would be coupled to terminals 12a and 12b via nodes 66a and 66b, respectively. In sum, each inverter phase is characterized by two transistors connected as described above. Each inverter phase has two associated inputs (one for each semiconductor switch), one output, and a first and second node.

Power supply 12 may be from a battery or other power source, such as an AC to DC converter. As noted above, additional components such as capacitors, inductors or diodes may be coupled to terminals 12a or 12b as necessary to stabilize the DC voltage. The voltage at 12b may be common (ground) or it may be a voltage of the same magnitude and opposite polarity as the voltage and magnitude at terminal 12a.

A control unit 38 contains logic to drive gates 1 through 6. Among other functions, the control unit 38 may execute the control algorithm and supply the switching signals to the inverter stage to provide the appropriate PWM signals. Digital control techniques allow the PWM control algorithm to be easily modified through software without the need for component changes or costly inverter redesign. A control unit may, for example include a digital signal processor (DSP) or microcontroller unit (MCU) as described above. An example of such a unit is Motorola's® MC33033P™, which is a PWM control logic device which may be used in brushless DC motor applications for driving the inverter stage. The inverter stage, in turn, provides PWM signals to a polyphase induction motor, such as a three phase induction motor 31 as shown in FIG. 2.

As an illustration, in an induction motor 31 where the energy through each load is 120 degrees out of phase from the other two phases, a polyphase inverter may be used to provide PWM signals to the motor at the proper phase. A variety of PWM modulation methods are available, and any such method may be used without departing from the scope of the invention. PWM signals in general may be used in a variety of ways to operate the motor. For instance, the three phase inverter of FIGS. 1 and 2 may drive an induction motor that requires sinusoidal current. The three-phase induction motor 31 of FIG. 2 may also require for proper operation that sinusoidal current flow at a relatively low frequency through the windings associated with each of the three phases. Note that, for the purposes of this example, each phase of the three phase motor may be modeled by the inductor-resistor loads 32/35, 33/36, and 34/37 of FIG. 1. As demonstrated below, PWM may be used to generate these sinusoidal currents. In other applications, the required currents may increase linearly with time. Whatever the required current flow, using PWM, a polyphase inverter may manage the motor's speed, torque and direction by simply using the digital circuitry to electronically switching or modulating the motor's input voltage to produce the desired current.

Pulse Width Modulation (“PWM”)

PWM is a modulation method which uses a constant switching or carrier frequency, a constant voltage amplitude, and a changing duty cycle to control the current in an inductive load. The resulting current through the load effectively “tracks” the changes in duty cycle. In an electric motor application, the switching frequency (i.e., the carrier frequency) of a PWM voltage waveform is typically on the order of Kilohertz. The motor frequency is ordinarily much lower, often on the order of 40-90 Hz. (These numbers are mere illustrations for certain applications, and are not essential to practicing the principles of the invention.) The rate at which the duty cycle of the waveform is changed dictates the magnitude and frequency of current running through a phase of the motor.

Referring back to FIG. 1, switches 25 and 28 are configured as an inverter phase. When switch 25 is turned on and switch 28 is turned off and a current path is available, current will flow through 25 into the load and the voltage at output 9 will switch to the positive power supply (assuming that transistor 25 is an ideal switch). Then, when switch 28 is turned off and switch 25 is turned on, the voltage at output 9 will go the negative supply (assuming that transistor 28 is an ideal switch) and if a current path is available, current will flow in the reverse direction, back from the inductive load through transistor 28. The result is an AC voltage waveform at output 9 relative to the supply that varies with time from the positive to the negative supply, and that provides varying pulse widths at a carrier frequency selected by the input control logic. In the example of the three phase motor above, the other two phases characterized by switch set 26/29 and 27/30 interoperate to produce current sources and sinks for each phase. The nature of the load is different depending on the application. Generally, for a three-phase load, similar waveforms with an identical carrier frequency are output from each inverter phase into each load but each waveforms is out of phase from the other two by 120 degrees each. (Not all phases require an identical carrier frequency depending on the application). In various multi-phase electric motors, the interaction between the various phases and the line-to-line voltages may become complex, but the general principles regarding phase separation, induction per phase, and the generation of current flow separated in phase remain substantially the same.

The reactance looking into each phase of the motor differs depending on how the windings of the motor are configured and how the motor itself works. Generally, the reactance is characterized in part by a resistance associated with the coil and an inductance L which is partially set by the number of turns used in the motor's windings. The applied PWM voltage at a phase induces a voltage across the phase windings, which in turn induces current flow. Accordingly, the PWM voltage directly proportional to the voltage across the equivalent inductance L:
Vpwm∝Ldi/dt
Hence:
I∝L∫vdt
This relationship demonstrates that in general, the current is directly proportional to the equivalent inductance of the load times the area of the voltage pulses over a given period of time. The exact voltage and current relationships can become complicated depending on the nature of the per-phase load. Nevertheless, the above equations show that the inductance has the effect of integrating or smoothing out the high frequency voltage pulses injected into the load. To increase the current in a phase of the load, the duty cycle (and hence the average voltage over a period) is increased gradually, which increases the average voltage and hence the current. In other words, the variance in current ideally follows the variance in duty cycle.

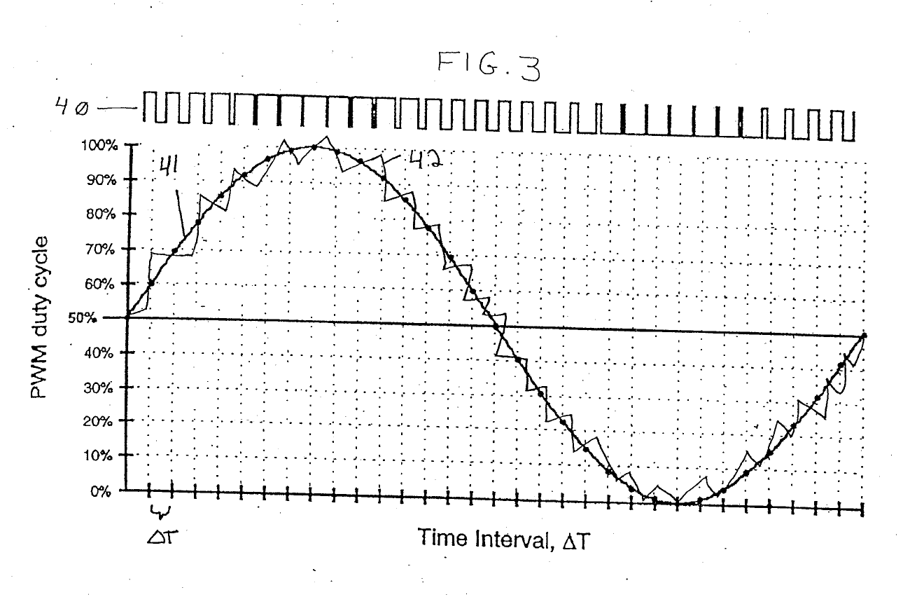

For illustrative purposes, an example of a sinusoidal PWM modulation scheme to drive an AC induction motor is shown in FIG. 3. The vertical axis on the chart in FIG. 3 represents the duty cycle of a single phase, and the horizontal axis represents the occurrence of time intervals AT, where T=1/f_{carrier}. The carrier frequency represents the switching frequency of the output PWM signal. Here, waveform 40 represents the voltage waveform at output 9 of FIG. 1 relative to the supply voltage. The carrier frequency or switching frequency of waveform 40 is constant. Only the duty cycle, or the width of the pulse relative to the total period, is changing. As can be seen, the duty cycle is changing in a manner commensurate with that of a sine wave. A 50% duty cycle as seen in the first pulse of waveform 40, represents a zero current, a 100% duty cycle represents a maximum positive current, and a 0% duty cycle represents a maximum negative current. Ideally, waveform 41 is produced, which is a smooth current corresponding precisely to the fundamental frequency of the changing duty cycle within the output waveform of the inverter. The other two phases can be used to produce sinusoidal currents that are separated from each other by 120 degrees, thereby creating a rotating magnetic field in the stator of the induction motor. Note that, while sinusoidal PWM modulation is portrayed here for illustrative purposes, the basic principles of changing the duty cycle at a constant magnitude and carrier frequency to obtain a corresponding change in the output current is applicable for all types of PWM modulation and can be used in both AC and DC motors, among many other applications. In other applications, a variable duty cycle may have a different effect on the motor. In sum, duty cycle controls the current in an inductive load. Ideally, the current is predictable for any application, and hence the required PWM modulation scheme can be readily ascertained.

In FIG. 3, assuming ΔT=400 microseconds, then f_{carrier}=2.5 kHz. Noting that one period of the sine wave 41 in FIG. 3 Tₛᵢₙ=32×ΔT=0.0128 seconds, the frequency of the motor=1/0.128=78.1 Hz.

Ripple Current

In reality, the output current in the exemplary sinusoidal PWM technique shown in FIG. 3 will not precisely track the desired sine wave 41. Rather, the output current will resemble something more like the jagged current of waveform 42. This variation in output current is typically known as the ripple current. Ripple current is primarily due to the harmonics contained in the PWM voltage waveform. Where the switching frequency is too low relative to the impedance of the load, the harmonic frequencies will be included in the output. To a lesser extent, ripple currents can also be produced by the non-ideal properties of an inverter circuit such as that in FIG. 2, including (i) the finite voltage across the switching transistors, (ii) the requirement of dead time to ensure that no two switches in a phase occur simultaneously, and (iii) variations in the dc power supply, particularly where the dc power supply is the output of an ac-dc converter.

If the inductance of a phase of the motor is proportionately large, ripple currents will ordinarily be low regardless of the switching frequency. In that situation, the harmonic components of the applied PWM voltage are much less significant than the fundamental motor frequency (here, approximately 78.1 Hz). With a high inductance, the impedance of the motor at the harmonic frequencies is much higher than at the fundamental frequency dictated by the duty cycle. In essence, where the inductance is high, a low pass filtering effect of sufficient magnitude exists where energy components at higher frequencies (and hence ripple currents) are attenuated at the output by the impedance of the load at a particular phase. Such an impedance is approximately equal to the sum of the inductance looking into the load plus the parasitic resistance of the load windings, i.e.,
Z=jwL+R
In sum, at higher frequencies, the inductance of the motor tends to minimize the ripple current, and the operation of the motor or other application is not significantly affected by the harmonics of the switching frequency. In FIG. 3, for the larger inductances of many AC motors, waveform 42 may well more closely resemble the ideal waveform 41.

Unfortunately, for a number of applications, the inductance associated with a particular phase is proportionately low. This low inductance means that, for the same carrier frequency, the ripple current will be much higher. High ripple currents inject potentially unacceptable amounts of noise into the motor or other circuit. If the ripple current is high enough, this can cause the output to operate outside of its specified characteristics. In the case of an electric motor, for example, increased ripple current will mean decreased control over the torque and speed of the motor. Where the ripple current is high enough, the motor can fail altogether because it is not operating within its proper current range.

The problem is exacerbated when the power supply provides a high voltage amplitude. In this case, the PWM waveforms have a large voltage amplitude. This large amplitude means that harmonic components of the PWM waveforms will also have a larger amplitude, thereby producing larger output ripple because the input to the load will consist of large voltage steps. Further, in high power applications, the magnitude of the current flowing through the inverter switches can be quite large, meaning high power losses in the inverter (see below) and high ripple at the output.

An exemplary application that is adversely affected by the excessive ripple of conventional inverters is the “coreless” brushless DC motor. In such motors, the permanent magnets and (in some cases) the back iron rotates, with only a thin stationary winding in the airgap. A significant advantage of this motor is that it has little to virtually no iron loss due to eddy currents and noise. Unfortunately, the winding inductance of this type of motor can be many times less that that of traditional slotted motors, leading to greatly increased copper and semiconductor losses when powered by traditional inverters. When a conventional inverter is used, large output ripple can be produced in such a motor.

One natural solution would be to increase the switching frequency of the PWM waveforms. Increasing the switching frequency effectively increases the harmonic frequencies associated with the PWM waveforms without affecting the fundamental frequency governed by changes in duty cycle. Because harmonic components of the signal exist at a higher frequency, those components are attenuated by the higher impedance due to the reactance of the inductor and the low-pass-filter effect of the inductor and series resistance.

Switching Losses

Unfortunately, the increase of the switching frequency comes at a great expense. Whatever the application, a power loss in a polyphase inverter occurs every time a transition (switch of a transistor in a phase) occurs. For example, a 10 KHz PWM frequency will have 10 times more transitions per second than a 1-KHz PWM frequency. Assuming the switching current is identical through each transistor, the motor's power stage will incurs at least ten times more switching power loss than will a power stage operating at 1 KHz.

High PWM frequencies generate greater heat loss in a given transistor. This increased heat loss decreases the reliability of the transistor. Moreover, higher PWM frequencies create greater switching transients which inject more noise into the motor. Moreover, since the PWM waveforms emulate square waves, significant radio frequency interference can be generated by the rising and falling edges of the voltage pulses. The interference is proportional to the transitional speed of the PWM waveform edges, the PWM carrier frequency, and the amount of current switched at each edge. In effect, at a given current, the higher the PWM frequency, the more RF interference is generated.

Hence, a competing consideration in designing an inverter circuit is to select as low a PWM carrier frequency as the application will allow. This design consideration runs afoul of the objective to maintain low ripple current by using higher carrier frequencies.

Placing inductors in series with the load would increase the output inductance without requiring a prohibitively high carrier frequency. However, this configuration adds mass and bulk to the circuit and typically introduces parasitic values that result in reduced performance. Depending on the application, the introduction of series inductors can adversely affect the frequency characteristics of the load to a point where circuit performance is unacceptably degraded.

A novel polyphase inverter is therefore disclosed to overcome these deficiencies. The polyphase inverter uses subphases and averaging transformers to significantly increase the PWM carrier increase without a corresponding increase in power loss and noise due to switching transients. The new inverter also reduces the voltage steps seen at the input of each load, which greatly attenuates output ripple. The novel inverter includes M phases, where M is an integer greater than one. For each phase the inverter includes N subphases in an inverter configuration, where N is an integer greater than one. The output of each subphase is coupled to one input of N inputs associated with one of M transformers, each transformer having an output for coupling to one of M phases of a load.

Using the split-phase inverter of the present invention, a digital circuit can create a PWM signal for each of the N subphases. The switching frequency of each signal may be set at a level which is low enough such that the amount of switching losses and RF interference is well within tolerable ranges. The duty cycle of each pulse width is chosen such that the desired amount of energy will be transferred to each of the M outputs. In this novel inverter, the number of inverter inputs increase from 2×M to 2×M×N. The choice of N and M are application specific, although M will typically be equal to three when the polyphase inverter is used to drive an electric motor.

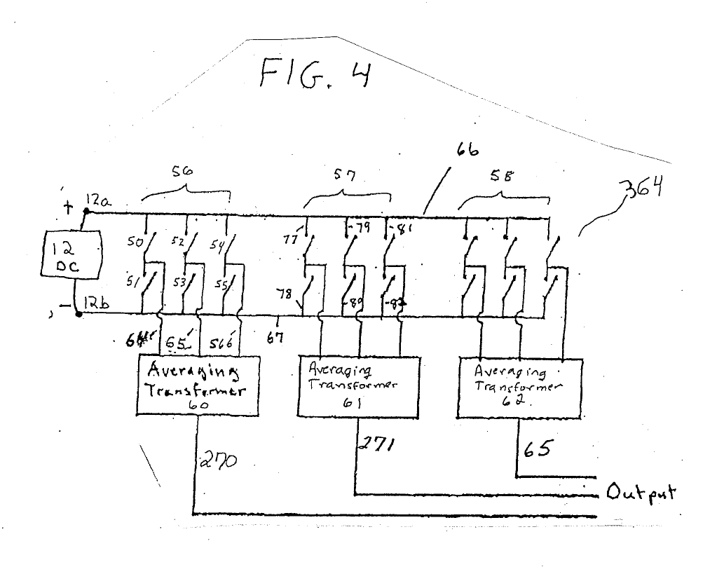

FIG. 4 is a drawing of a split phase inverter 364 with subphases according to an exemplary embodiment of the present invention. M is an integer equal to the number of phases of the polyphase inverter. M=3 here. N is an integer equal to the number of subphases. Each phase 56, 57 and 58 is split into N subphases. N=3 in this embodiment. Thus, in the novel inverter, three subphases comprise a single phase. Each subphase is an inverter having two inputs, and output, and first and second nodes. Conductors 66 and 67 are coupled to each side of the subphases for providing DC power to the subphases.

As noted, the split-phase inverter of FIG. 4 includes three phases 56, 57, and 58. Each phase includes three subphases. For example, phase 56 of inverter 364 includes a first subphase characterized by semiconductor switches 50 and 51 in an inverter configuration, a second subphase characterized by semiconductor switches 52 and 53 in an inverter configuration, and a third subphase characterized by semiconductor switches 54 and 55 in an inverter configuration. The other two phases 57 and 58 are split in a similar manner.

The output of each subphase in FIG. 4 goes is coupled to one of N (3) inputs of an averaging transformer. One averaging transformer is associated with each of the M (3) phases. Therefore, M averaging transformers are used, each with N inputs and one output for coupling to a load. In other embodiments, the functionality of an averaging transformer may be accomplished by using a plurality of transformers; in those embodiments, the plurality of transformers would be considered for the purposes of this disclosure to be one of the M transformers.

For example, output 64 from the subphase inverter defined by switches 50 and 51 is coupled to a first of N (3) inputs of averaging transformer 60. Likewise, output 65 from the subphase inverter defined by switches 52 and 53 is coupled to a second input of averaging transformer 60. Output 566 from the subphase inverter defined by switches 54 and 55 is coupled to a third input of averaging transformer 60.

Like phase 56, phases 57 and 58 are each subdivided into three subphases and may be coupled, respectively, to averaging transformers 61 and 62 in a configuration identical to phase 56 and its corresponding subphases. Each transformer 60, 61 and 62 has a corresponding output 270, 271, and 65, respectively. Those outputs each provide power to one of the N loads.

As in FIG. 1, each of the vertical pairs of semiconductor switches are coupled in an inverter configuration. Conductors 66 and 67 are used to provide DC power to the inverter load from terminals 12a and 12b of DC power source 12. Each inverter subphase includes two nodes, a first node and a second node. For example, the three inverter subphases in phase 57 contain first nodes 77, 79 and 81, respectively. Likewise, the same three inverters contain second nodes 78, 80 and 82. Each of the remaining six inverter subphases (three in phase 56 and three in 58) contain first and second nodes in the same manner. Like in FIG. 1, the first nodes of each inverter are coupled to conductor 66, and the second nodes of each inverter are coupled to conductor 67, meaning that one conductor supplies a power source by connecting terminal 12a to the nodes at each of the switches at the first nodes of the polyphase inverter and that the other conductor provides a power sink by connecting the terminal 12b to the nodes at each of the switches at the second nodes of the polyphase inverter.

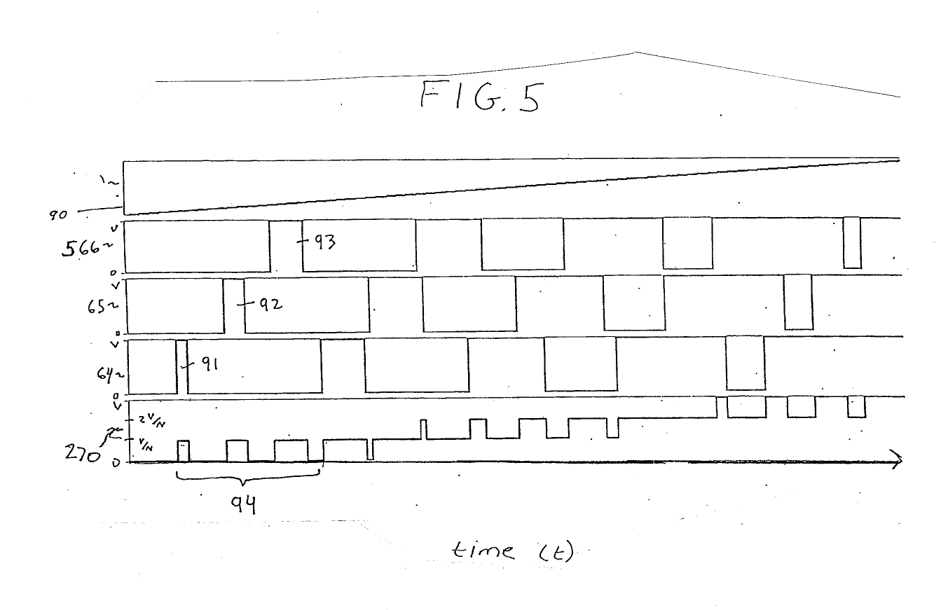

As in FIG. 1, the input to the various switches is not shown for clarity. However, the switches may be formed using a variety of transistor types, such as IGBTs or power MOSFETs. A digital circuit is used to drive each subphase of the split-phase inverter 364. PWM pulses are produced by control logic or software and are provided to the input gates of each transistor switch. Corresponding pulses at the output for each subphase are produced at a selected switching frequency. Assuming that the same power supply 12 is connected to the split phase inverter and that the switching frequency for each subphase is identical to the switching frequency of the inverter in FIG. 1, each transistor will switch only 1/N (and perhaps less) of the total current as switched by the transistors of the inverter in FIG. 1. This decrease in current is due in part to the fact that each transistor in a given subphase conducts current, on average, for approximately 1/N of the time as for a similarly-configured circuit of FIG. 1 driving an identical load (See FIG. 5, below). Accordingly, the total switching losses of the conventional inverter and the inverter of the present invention would be substantially identical.

The averaging transformers 60, 61, and 62 may perform two functions: (i) they add the train of pulses from each subphase together to form a single signal having a frequency that is approximately N times greater than the switching frequency of the individual subphases, and (ii) they step down the voltage so that the load “sees” voltage steps of approximately V/N. In this case, the switching frequency at the output of the transformer (and hence the input to the load) is three times greater (N=3) and the voltage steps injected into the load are three times less (V/3), meaning that the harmonics at the output are attenuated greatly due to the smaller voltage changes and very high impedance of the load by virtue of the tripled output frequency (Z=jwL+R). The net effect is that the output ripple current is significantly reduced without a corresponding increase in switching losses in the split-phase inverter. The addition of the transformers produce only minimal losses and their output characteristics are much easier controlled than that of the inverter. In many cases, the averaging transformers are smaller than any series inductors that would otherwise be used, meaning that the transformers in these cases are not associated with the mass and bulk of the series inductor “fix.”

The PWM works the same, except the PWM voltages for each subphase are modified to ensure that the proper amount of current is applied to the load. So for example, phase 56 of FIG. 4 may split one big duty cycle pulse into 3 (N) smaller pulses. In particular, semiconductor switches 50 and 51 will first emit a short pulse, then semiconductor switches 52 and 53 emit a short pulse, and thereafter switches 54 and 55 emit a short pulse. When the currents from the three signals are added together (see below), the result is a duty cycle which is identical to that of a phase from a conventional polyphase inverter. Phases 57 and 58 behave similarly, except that they are driving different outputs. Accordingly, they may be providing different modulated signals, or the same modulated signals at a different phase, depending upon the application.

During the next cycle, the three subphases of phase 56 may again provide three pulses, one for each transistor. The carrier frequency for each subphase is the same as if phase 56 used only one inverter and emitted wide pulses. For example, the inverter defined by switches 50 and 51 will operate at the same frequency as in a conventional inverter, but will produce shorter pulses. The same is true for each subphase in each phase of the split-phase inverter of FIG. 4. Moreover, as discussed above, because the pulses are much smaller, each transistor only switches approximately 1/N of the total current through any given subphase. Accordingly, the power loss and noise due to transients does not increase.

The output of the three signals enter an averaging transformer, which adds the currents of each cycle into one signal and which steps the switching voltage amplitude down by a factor of N. The transformer may have a turn ratio of N:1, thereby stepping the voltage down at the output. Further, because the transformer effectively sums the pulses of the signals together, the carrier frequency is switched to be N times greater without any effect on electromagnetic interference, power loss or noise on the inverter due to the necessity for increased switching transients. Not only will the losses in the inverter (see below) be smaller, but the heat due to the power loss will not strain the reliability of the transistors in the inverter. Further, the transformers can be strategically placed so as not to inject excessive noise into the inverter or the load.

In addition to summing the frequencies to get an increased carrier frequency and hence a significant reduction in output ripple, the averaging transformer steps down the voltage transients. In one embodiment, the reduction is V/N, where V is the change in voltage amplitude achieved by the inverter stage. Accordingly, not only does the load see a higher frequency, but it also sees lower changes in amplitude. This means that the harmonic components of the PWM signal will be much smaller in amplitude. The combination of the increased impedance at the load due to the high switching frequency and the lower voltage amplitudes injected into the load means that output ripple current will be minimal—and not at the cost of increased power loss and electromagnetic interference.

FIG. 5 is a graphical representation of the output waveforms produced by the split-phase inverter circuit in accordance with an embodiment of the invention. As will be seen, in one embodiment each of the N subphases operates at the same duty cycle but with the carrier phase shifted by 360 degree/N relative to each of the other subphases. In FIG. 5, as can be seen, the duty cycle of the waveforms are selected so that the duty cycle (waveform 90) is increased linearly with time. This may in many applications provide a linear current through the load. It should be noted that FIG. 5 describes the activity of only one of the subphases; however, the other subphases will behave similarly. Waveform 64 represents the output 64 in FIG. 4; waveform 65 represents the output 65 in FIG. 4; waveform 566 represents the output 566 in FIG. 4, and waveform 270 represents the output to the transformer 60 in FIG. 4. The top waveform 90 represents the variance in duty cycle that is provided by the modulating waveforms 64, 65 and 566. Using these waveforms, a linear increase in current may be achieved through an inductive load coupled to the output 270 of the transformer, substantially free of output ripple.

The voltage “v” in FIG. 5 represents the maximum voltage swing permitted by the power supply. It is assumed for purposes of this diagram that the square waves are ideal with 0 rise and fall times and that no voltages appear across the semiconductor switches. It is also assumed that terminal 12b of the power supply represents common.

Waveform 64 is output from the inverter defined by switches 50 and 51 to produce a first pulse 91. Thereupon, waveform 65 produces a second pulse 92 and waveform 566 produces a third pulse 93. Note that the frequency f_{carrier} in each of the waveforms 64, 65 and 566 are constant; only the duty cycle of each waveform varies and the phase of each waveform is different by 120 degrees. The three pulses are input to a corresponding transformer (60 in FIG. 4). The transformer averages the voltage outputs of the N subphases while adding the currents. That is, the transformer sums the pulses to produce a signal with a frequency N×f_{carrier}. In this case, the frequency is tripled. This increase in frequency can be seen in waveform segment 94 of transformer output 270. The transformer produces a maximum voltage amplitude of v/N. That is, the maximum voltage step seen by the load is v/3. Even in later portions of the waveform, there is never a voltage step that changes from 0 to v. The portion 94 of waveform 270 shows the reduction in amplitude of the three pulses 91, 92 and 93 to v/3.

The result of this embodiment is that the voltage steps seen by the load are v/N and the PWM carrier frequency is N times greater than the switching frequency of the subphases. The combination of these two effects reduces the ripple current by a factor of approximately N². In the case of a motor drive where the line to line waveforms collectively determine the ripple currents, the precise analysis is more complex, but to the first order the N² improvement applies for N>2. The result in FIG. 5 is a current flow through output 63 that tracks the increase in duty cycle, as shown by waveform 90.

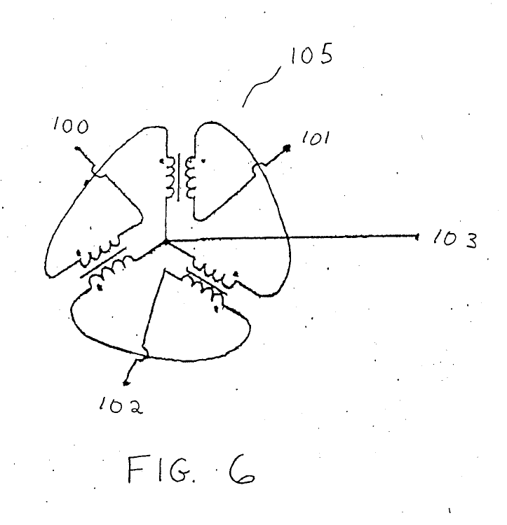

A variety of ways exist to construct the combining transformer. A transformer 105 suitable for any value of N with appropriate modification is depicted in FIG. 6. In FIG. 6, N=3. The output from a first subphase (64 from FIG. 4) represents a first transformer input 100, the output from a second subphase (65 from FIG. 4) represents a second transformer input 101, and the output from a third phase (66 from FIG. 4) represents a third transformer input 102. The transformer output 103 is analogous to output 270 in FIG. 4. The common output 103 to the transformer 105 receives pulses from each of the subphases at inputs 100, 101 and 102. The current from each of these subphases is added together. The number of turns in each winding of the transformer are selected so as to step down the voltage from each pulse by N:1.

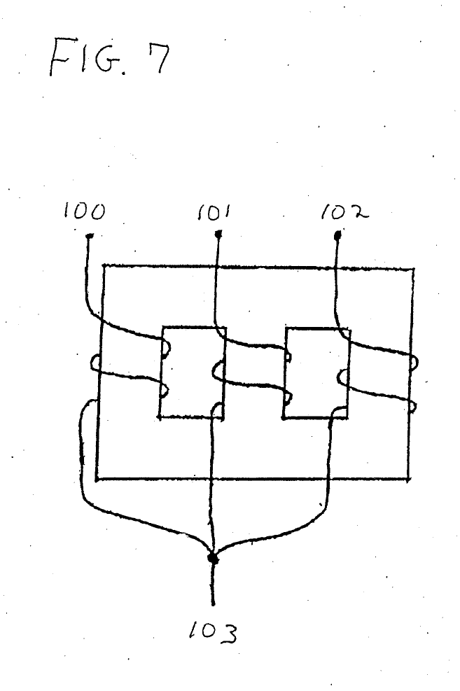

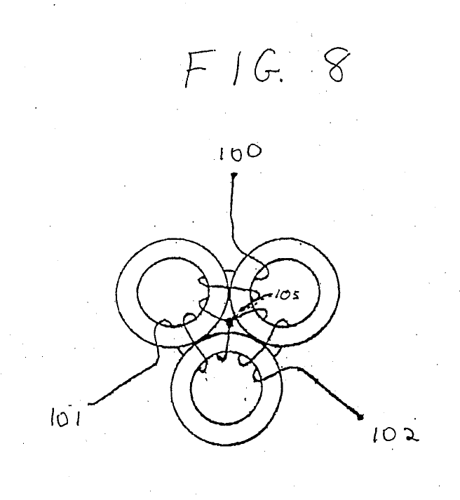

The transformer 105 of FIG. 6 can be constructed in a variety of ways. For example, the transformer 105 may be designed with N cores having two windings each, and with an El type core having N legs, as depicted in FIG. 7. Here, the subphase outputs are fed through three cores, each core having two windings. The transformer output is produced by summing the currents from each of the conductors into one conductor 103. Another suitable transformer design is the toroid configuration shown in FIG. 8. Each of the three subphase outputs are input into the transformer at inputs 100, 101 and 102, as in the other embodiments. In FIG. 8, N toroids are arranged in a circle and the load and transformer output is connected to center point 105.

In some cases it may be desirable to construct the transformers of FIGS. 6-8 using bifilar or concentric windings connected as in FIG. 6 to prevent the leakage flux from saturating the core.

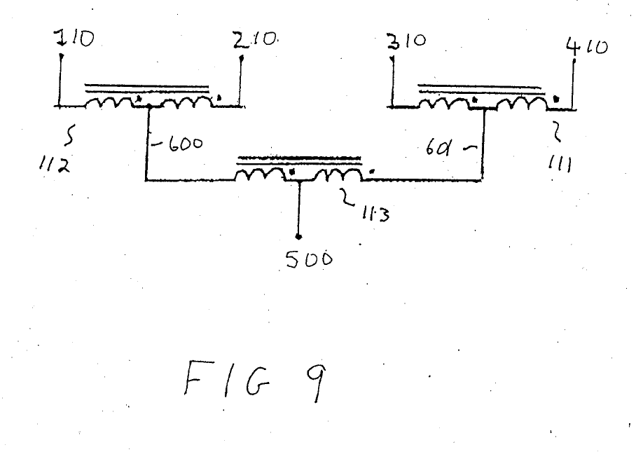

When N is a power of 2, it is possible to use cascaded center tapped transformers, such as the one in FIG. 9. In FIG. N, N=4 and the four inputs 110, 210, 310 and 410 are sent through the cascaded center tapped transformers 111 and 112. The output signals 601 and 602 add the current from each of the four subphases and are input into transformer 113. The resulting output 500 of transformer 113 is sent to the load. FIG. 9 is an example where one averaging transformer actually includes a plurality of transformers to achieve the objectives of adding the frequencies and reducing the output voltage. Generally, when this configuration is used, the matching of the resistance from each subphase to the load and the duty cycles should be precise enough to avoid undesirable saturation currents in the transformers. The switching dead-time associated with the transistors in the subphases may be used in this instance to provide a small flyback equalization period. In practical circuits with digitally generated PWM signals, the matching requirements may be readily fulfilled.

As noted above, one of the many promising applications for the split phase topology as illustrated in FIG. 4 is for driving “coreless” brushless DC motors. These motors have little to virtually no iron loss. However, as explained above, the winding inductance can be proportionately very small, particularly when compared to other traditional slotted stator motors. With the use of a split-phase drive in accordance with an embodiment of the invention, very substantial efficiency improvements are possible. The DC to shaft efficiency can be within a few percentage points of the theoretical motor efficiency. Further, the averaging transformers can be much smaller than series inductors. The efficiency improvement over traditional drives is greatest at motor speeds less than the maximum that the power supply will allow.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A polyphase inverter comprising;
a first conductor;
a second conductor;
M phases, each phase comprising N inverters, each inverter comprising two inverter inputs, an inverter output, a first node coupled to the first conductor and a second node coupled to the second conductor; and
M transformers, each transformer comprising N transformer inputs and a transformer output, each of the N inverter outputs from each phase coupled to each of the N inputs of an associated one of the M transformers.

2. The polyphase inverter of claim 1 wherein M=3.

3. The polyphase inverter of claim 1 wherein the each of the M transformer outputs is configured to drive an electric motor.

4. The polyphase inverter of claim 1, wherein N=3.

5. The polyphase inverter of claim 4, wherein M=3.

6. The polyphase inverter of claim 1, wherein each inverter comprises two insulated-gate bipolar transistors.

7. The polyphase inverter of claim 1, wherein each inverter comprises two metal-oxide-semiconductor field effect transistors.

8. The polyphase inverter of claim 1, wherein each of the M transformers comprises N cores.

9. The polyphase inverter of claim 1, wherein each of the M transformers comprises N toroids.

10. The polyphase inverter of claim 1, wherein each of the M transformers comprises a plurality of center-tapped transformers.

11. The polyphase inverter of claim 1, further comprising a logic circuit comprising 2×M×N outputs, each output coupled to one of the 2×M×N inverter inputs.

12. The polyphase inverter of claim 11 wherein the logic circuit is used to provide PWM signals to the inverters.

13. A polyphase inverter comprising:
logic circuitry;
a first conductor for coupling to a first terminal of a DC power source;
a second conductor for coupling to a second terminal of the DC power source;
M phases, each phase comprising N subphases, each subphase comprising two transistors coupled in an inverter configuration, an first node coupled to the first conductor, a second node coupled to the second conductor, two inverter inputs coupled to the logic circuitry, and an inverter output; and
M transformers, each transformer comprising N transformer inputs, the N transformer inputs of each transformer being coupled to the N inverter outputs from an associated one of the M phases, and a transformer output for coupling to a load.

14. The polyphase inverter of claim 13 wherein M=3.

15. The polyphase inverter of claim 14 wherein the three transformer outputs are configured to supply power to an electric motor.

16. The polyphase inverter of claim 15 wherein the M transformer outputs are configured to supply power to an electric motor.

17. The polyphase inverter of claim 13 wherein the transistors comprise insulated gate bipolar transistors.

18. The polyphase inverter of claim 13 wherein the transistors comprise metal-oxide-semiconductor field effect transistors.

19. The polyphase inverter of claim 13 wherein each transformer comprises N cores.

20. The polyphase inverter of claim 13 wherein each transformer comprises N toroids.

21. The polyphase inverter of claim 13 wherein each transformer comprises at least one center-tapped transformer.

22. The polyphase inverter of claim 13 wherein each transformer output is configured to drive a phase of an electric motor comprising M phases.

23. The polyphase inverter of claim 13 wherein each transformer multiplies a switching frequency associated with an output of the subphases by N.

25. The polyphase inverter of claim 23 wherein each transformer divides the maximum voltage step associated with the output of the subphases by N.

26. A system for driving an electric motor, comprising;
a polyphase inverter comprising a first conductor, a second conductor, M phases wherein each phase comprises N inverters, and wherein each inverter comprises two inverter inputs, an inverter output, a first node coupled to the first conductor and a second node coupled to the second conductor, the polyphase inverter further comprising M transformers, wherein each transformer comprises N transformer inputs and a transformer output, and wherein each of the N inverter outputs from each phase is coupled to each of the N inputs of an associated one of the M transformers; and
an electric motor comprising M phases, each phase comprising an input, the output of each transformer coupled to the input of each phase of the electric motor.

27. The system of claim 26 wherein the electric motor comprises a DC brushless electric motor.

28. The system of claim 27 wherein the motor is coreless.

29. The system of claim 28 wherein the electric motor comprises three phases.

30. The system of claim 26 wherein the electric motor comprises three phases.

31. A polyphase inverter comprising;
a first conductor;
a second conductor;
M phases, each phase comprising N inverters, each inverter comprising two inverter inputs, an inverter output, a first node coupled to the first conductor and a second node coupled to the second conductor; and
M transformers, each transformer comprising N transformer inputs and a transformer output, each of the N inverter outputs from each phase coupled to each of the N inputs of an associated one of the M transformers;
wherein each of the M transformers comprises an E-I core with N legs.
